(19) United States
(12) Patent Application Publication
(10) Pub. No.: US 2002/0087375 A1
(43) Pub. Date: Jul. 4, 2002

(54) Method for outbound shipment of packages direct from home or office using an unattended transfer device

(76) Inventors: Carter Griffin, Washington, DC (US); Timothy Ogilvie, Washington, DC (US); Mark Stein, Bethesda, MD (US); Stephen Ezell, Washington, DC (US)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/985,494

(22) Filed: Nov. 5, 2001

Related U.S. Application Data
(63) Continuation of application No. 09/718,357, filed on Nov. 24, 2000.
(60) Provisional application No. 60/167,253, filed on Nov. 24, 1999.

(51) Int. Cl. G06F 17/60

(52) U.S. Cl. 705/7

(57) ABSTRACT

A method for outbound shipment of packages directly from home or office includes the steps of registering a user, receiving authorization from the user to pay a shipping agent at least one fee incurred by the user, and receiving a notification from the shipping agent of the fee incurred by the user. The method further includes the steps of paying the fee directly to the shipping agent; and receiving reimbursement from the user for the payment of the fee to the shipping agent. The method further may include the steps of providing the user with a transfer device, and signaling the shipping agent to pick-up the package from the user. In addition, the package may be stored in the transfer device.

The present application claims priority from U.S. patent application Ser. No. 09/718,357, entitled: “Method for Outbound Shipment of Packages Direct From Home or Office Using An Unattended Transfer Device,” filed Nov. 24, 2000, and U.S. Provisional Patent Application Serial. No. 60/167,253, entitled: “System And Method For Outbound Shipment Of Packages (And Payment Of Shipping Fees) Direct From Home Using An Unattended Storage Device,” filed Nov. 24, 1999, the disclosures of which are incorporated herein by reference in their entireties.

### BACKGROUND OF THE INVENTION

1. Field of the Invention

The invention relates generally to the field of outbound shipment of packages. In particular, the present invention is directed to a method for outbound shipment of packages directly from home or office using an unattended transfer device.

2. Description of Related Art

Consumers today are busier than ever and are challenged to find a sustainable balance between work and family. As a result, consumers have shown a strong willingness to embrace innovations that bring convenience and flexibility to their lives. Two trends that illustrate this phenomenon are (a) telecommuting and other home-based work situations, and (b) convenience-driven self-service devices and utilities. It is estimated that there are over 10 million workers in the United States who telecommute (i.e., work from home rather than travel to their office to work) more than one day per week. That figure is in addition to the more than 24 million Americans who operate businesses from their homes. The dramatic rise in self-service innovations, such as automatic teller machines and Internet-based commerce, attests to how great the demand is for convenience and flexibility, especially when such convenience and flexibility are centered on the home.

One of the more unrewarding and time-consuming tasks for people who perform work at home or consumers, who lead busy lives, is the sending of outbound packages. These packages may be product returns for goods purchased through the Internet or via mail order catalogs, or work products developed at home and directed towards clients or co-workers. Such packages are an everyday fact of life for home-based workers and busy consumers, and this task of sending outbound packages would be greatly simplified if people could send packages directly from their homes.

### SUMMARY OF THE INVENTION

Home-based workers and consumers desire the ability to send packages and have them picked up when they are not at home. Moreover, a need has arisen for the ability to defer payment for the pick-up of such packages. Therefore, a need has arisen for a method for outbound shipment of packages directly from home or office. Further, a need has arisen for a method for outbound shipment of packages directly from home using an unattended transfer device.

In an embodiment of the present invention, a method for outbound shipment of packages directly from home or office is described. The method comprises the steps of registering with a network agent, preparing at least one package for pick-up, and affixing an identifier to each package. The identifier may provide identification of the user, the recipient, the sender, the shipping agent, or network agent or combinations thereof. The method further comprises the steps of authorizing the network agent to directly pay a shipping agent at least one fee, and reimbursing the network agent for the at least one fee paid directly to the shipping agent by the network agent. The method further may comprise registering as a user of a transfer device, receiving the transfer device from the network agent, and inserting the at least one package in the transfer device for pick-up by the shipping agent.

In another embodiment of the present invention, a method for outbound shipment of packages directly from home is described. The method comprises the steps of registering a user, receiving authorization from the user to pay a shipping agent at least one fee incurred by the user, and receiving a notification from the shipping agent of the at least one fee incurred by the user. The method further comprises the steps of paying the fee directly to the shipping agent; and receiving reimbursement from the user for the payment of the fee to the shipping agent. The method further may comprise the steps of providing the user with a transfer device, and signaling the shipping agent to pick-up the package from the user via the device. Further, the package may be stored in the transfer device.

In yet another embodiment of the present invention, a method for outbound shipment of packages directly from home or office is described. The method comprises the steps of receiving a signal for a pick-up of at least one package, picking up the at least one package, and determining a treatment of the at least one package based on shipping options selected by the user. The treatment of packages may include the determination of shipping costs, including a base rate and additional or optional charges; identification of the designated payor for fees associated with each package; determining whether the packages bear any special instructions or markings (e.g., Fragile); sorting of packages for appropriate handling, routing, and shipment; and the like; and combinations thereof. The method further comprises the steps of calculating at least one fee associated with the pick-up of the at least one package, and identifying whether the user is a member of a network operated by a network agent. Network members may include users, shipping agents, returns receiving centers, merchants, and distribution centers. The method also comprises the steps of notifying the network agent of the at least one fee incurred by the user, and receiving payment from the network agent for the at least one fee incurred by the user.

In still yet another embodiment of the present invention, a method for outbound shipment of packages directly from home is described. The method comprises the steps of registering with a network agent, registering as a user of a transfer device, preparing at least one package for pick-up, and affixing an identifier to each package. The identifier may provide identification of the user, the recipient, the sender, the shipping agent, or the network agent or combinations thereof. The method further comprises the steps of inserting the at least one package in the transfer device, signaling a shipping agent to pick-up the at least one package from the transfer device, picking up the at least one package, and determining a treatment of the at least one package. The method also includes the steps of calculating at least one fee associated with the pick-up of the at least one package, which at least one fee is incurred by the user, identifying whether the user is a member of a network operated by the network agent, and notifying the network agent of the at least one fee incurred by the user. The method further comprises the steps of receiving authorization from the user to pay the at least one fee directly to the shipping agent, paying the at least one fee directly to the shipping agent, and receiving reimbursement from the user for the payment of the at least one fee to the shipping agent.

Other objects, features, and advantages will be apparent to persons of ordinary skill in the art in view of the following detailed description of the invention and the accompanying drawings.

### BRIEF DESCRIPTION OF THE DRAWINGS

For a more complete understanding of the present invention, the needs satisfied thereby, and the features and advantages thereof, reference now is made to the following descriptions taken in connection with the accompanying drawings in which:

FIG. 1 depicts a flush-mounted unattended transfer device according to an embodiment of the present invention;

FIG. 2 depicts an unattended transfer device with a one-way mechanism according to an embodiment of the present invention;

FIG. 3 depicts a secure door system according to an embodiment of the present invention;

FIG. 4 depicts secure door system having a full-size door according to an embodiment of the present invention;

FIGS. 5a-b depict a subterranean enclosure transfer system according to an embodiment of the present invention;

FIGS. 6a-b depict a tether transfer system according to an embodiment of the present invention;

FIG. 7a-c depict a peg board transfer system according to an embodiment of the present invention;

FIG. 8a-b depict a sensor transfer system according to an embodiment of the present invention;

FIG. 9 is a flow chart depicting a method for outbound shipment of packages directly from home or office, according to an embodiment of the present invention;

FIG. 10 is a flow chart depicting a method for outbound shipment of packages directly from home or office, according to another embodiment of the present invention;

FIG. 11 is a flow chart depicting a method for outbound shipment of packages directly from home or office according to yet another embodiment of the present invention; and

FIG. 12 is a flow chart depicting a method for outbound shipment of packages directly from home or office according to still yet another embodiment of the present invention.

### DETAILED DESCRIPTION OF PREFERRED EMBODIMENTS

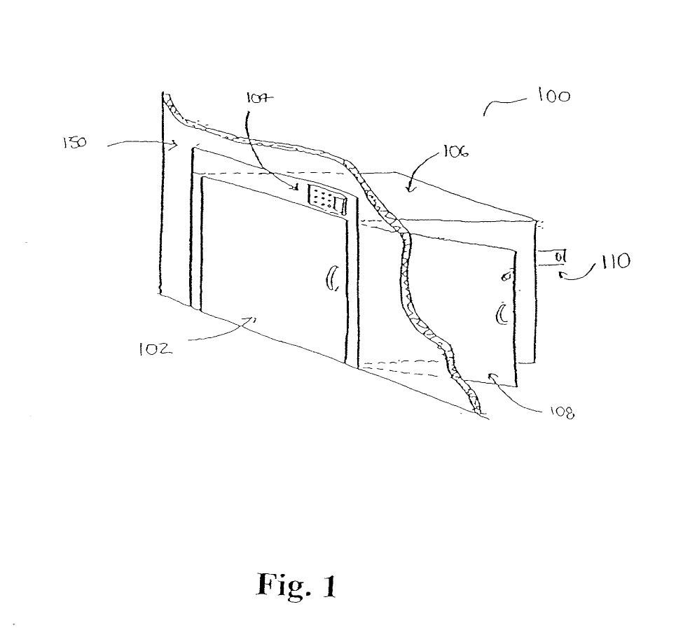

Preferred embodiments of the present invention and their advantages may be understood by referring to FIGS. 1-12 like numerals being used for like corresponding parts in the various drawings. The term “transfer” is used throughout this document. As used in this application, this term includes shipping, delivery, and storage of goods.

The present invention is preferably used in conjunction with an unattended delivery or transfer device, such as the device described in U.S. Pat. No. 5,774,053 to Porter, entitled “Transfer device for the Delivery and Pickup of Goods,” the disclosure of which is incorporated herein by reference. The unattended transfer device preferably is equipped for one way or two way communications, whether they be wireless or landline or combinations thereof, or the like. In an embodiment, a wireless network may be used. In another embodiment, telephone lines may be used. In yet another embodiment, the radio spectrum may be used.

Other types of unattended transfer devices also may be used. For example, referring to FIG. 1, a flush-mounted unattended transfer device ( a controlled access door) is provided. Device 100 may be mounted in exterior wall 150 of a building, such as a house, a garage, an office building, or the like. Device 100 includes an access portal, such as exterior door 102, access controller 104, interior compartment 106, and interior door 108. Interior compartment 106 may be a solid-walled compartment, as shown in FIG. 1, or it may be a cage, or other secure enclosure.

Access controller 104 controls the access to interior compartment 106 by unlocking or locking exterior door 102. Access controller 104 may include an input device, such as a keypad a bar code reader, a voice recognition device, or the like, that allows a person to enter a code, such as an access code or a vendor or transaction code, into the device. A variety of input devices may function as access controller 104, including, but not limited to, an infrared receiver, a radio antenna, an optical scanner, a magnetic strip reader, a lock and tumbler, and combinations thereof.

Device 100 also may include locking mechanism 110 to prevent interior door 108 from being opened from the inside of interior compartment 106. Locking mechanism 110 may be a lock and tumbler device or a similar lock. In other embodiments, locking mechanism 110 may comprise a latch on the outside of interior door 108.

Device 100 may operate in a manner similar to the device disclosed in U.S. Pat. No. 5,774,053. Generally, during a delivery, access to interior compartment 106 may be granted by access controller 104, and an item for delivery may be placed within interior compartment 106. Exterior door 102 then is closed. For a shipment, a user may place an item in interior compartment 106 via either exterior door 102 or interior door 108.

Access controller 104 then transmits information to a remote location. This information may include, inter alia the access time, the access code, the number of packages, and the like. The information also may include a status of the device, such as device status (e.g., open or closed; battery status; empty, partially filled, or filled; communication signal strength; and the like.)

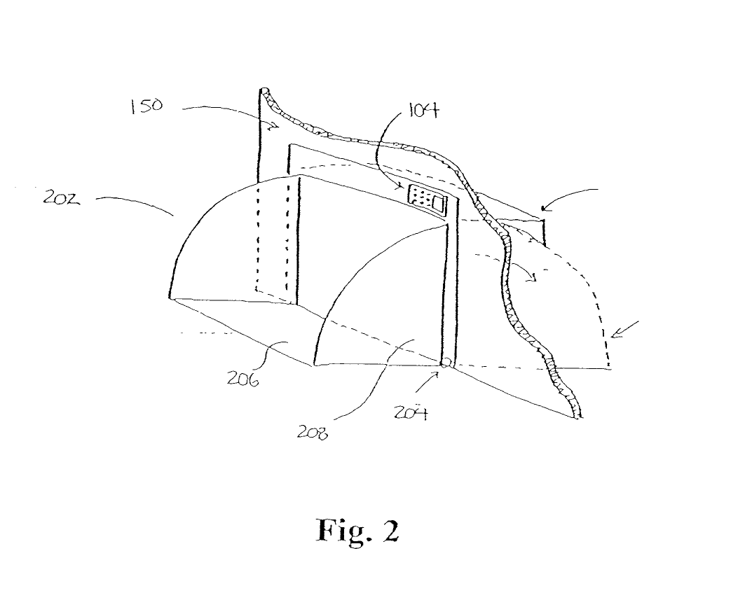

Referring to FIG. 2, an unattended transfer device with a one-way mechanism according to one embodiment of the present invention is provided. Device 200 includes access controller 104, which is substantially identical to that of flush mounted transfer device 100. One-way mechanism 200 also includes rotating door 202 that is mounted on hinge 204. As shown in the figure, rotating door 202 includes walls 206 and 208, which are mounted at a suitable angle to each other. In an embodiment, walls 206 and 208 may be substantially perpendicular to each other; other appropriate angles may be used.

Rotating door 202 may include at least one handle (not shown) for allowing the user to rotate rotating door 202 open or closed. During a delivery or a pick-up, when rotating door 202 is unlocked, rotating door 202 may be extended outward to accept item 210 or to allow removal of item 210. Item 210 may be placed on wall 206 of rotating door 202, and rotate rotating door 202 closed. Once rotating door 202 is closed, item 210 shifts to rest on wall 208 of rotating door 202. For shipping (or pick-up), the user is on the inside, the user may place item 210 on wall 208 of rotating door 202. If the user is on the outside, the process is substantially the same as a delivery.

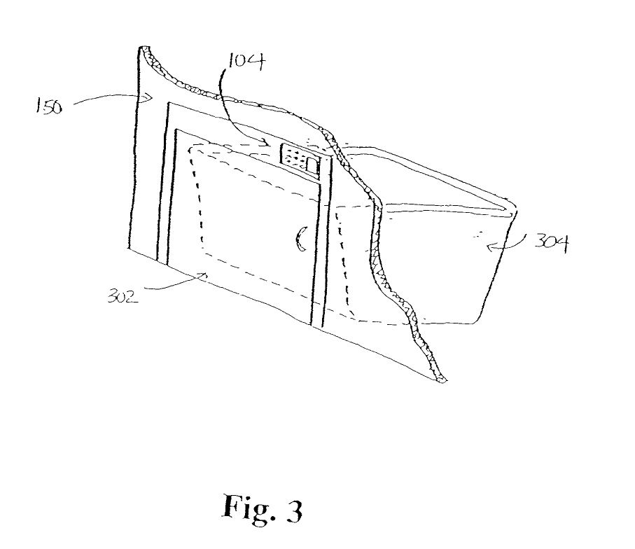

Referring to FIG. 3, secure door transfer system 300 according to an embodiment of the present invention is disclosed. In this embodiment, the user may decide to permit access to a limited area a building (es, a garage, a breezeway, a mud room, or the like) and protect the rest of the building through a separate security system. When access is granted by access controller 104, exterior door 302 is unlocked, providing access to the interior of a portion of the building. In an embodiment, external door 302 may open to reveal a tote or a basket (not shown), or simply an open area on the floor, onto which any deliveries or packages for pick-up may be placed.

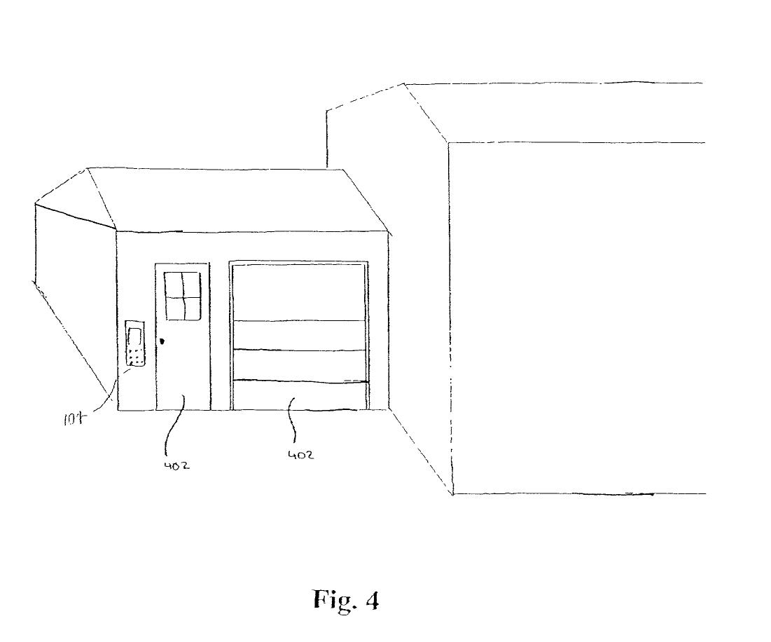

Referring to FIG. 4, in another embodiment, external door 402 of secure door system 400 may be a full size door, permitting an authorized person to enter an area of a building (eg, a garage or a separate building) to make a delivery or a pick-up. If necessary, security preventing access to the remainder of the building may be achieved by an additional security system, including locking a door to the building, or providing an electronic (e.g., motion detectors) or video surveillance system to prevent or announce entry into unauthorized areas.

In an embodiment, external door 402 may be an interior door of a building. For example, external door 402 may open to reveal a storage area, such as a room, a basement, and the like. Thus, the present invention may be used in both personal and commercial storage areas. In yet another embodiment, external door 402 may be used as a replacement for any conventional door.

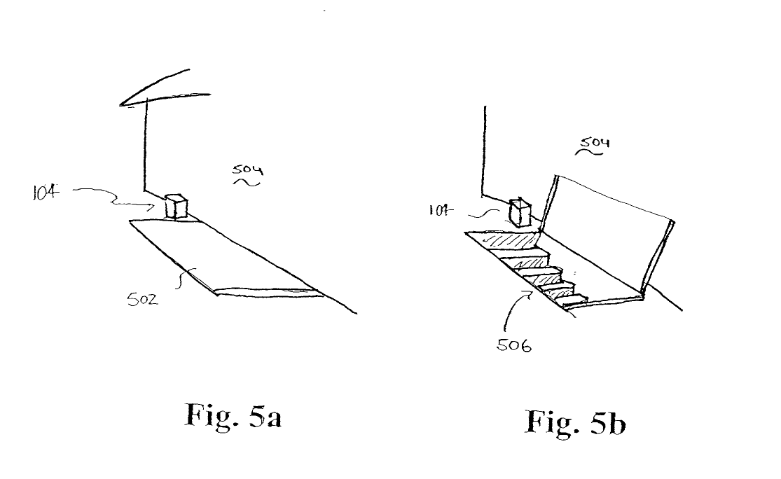

In another embodiment, a subterranean enclosure transfer system is disclosed. For example, referring to FIGS. 5a and 5b, a user may use access controller 104 to unlock access door 502 that is adjacent to building 504, which leads to enclosed underground area 506, such as the entrance to a storm cellar. The user gains access to area 504 through external door, 502, or through an internal door (not shown) similar to those described above. This embodiment may be less obtrusive from an aesthetic standpoint, but also may benefit from temperature control advantages provided by subterranean thermodynamics ( substantially constant year-around temperatures of about 55° F.).

Alternatively, a “safe zone” may be provided into which packages may be inserted and from which they may not be removed without triggering an alarm. The safe zone for unattended transfer may be a section of a property, including a porch, a deck, a carport, or other designated area that may be adjacent to or near a building or house. Security may be provided through some non-enclosed means of attachment or sensing, as will be discussed below.

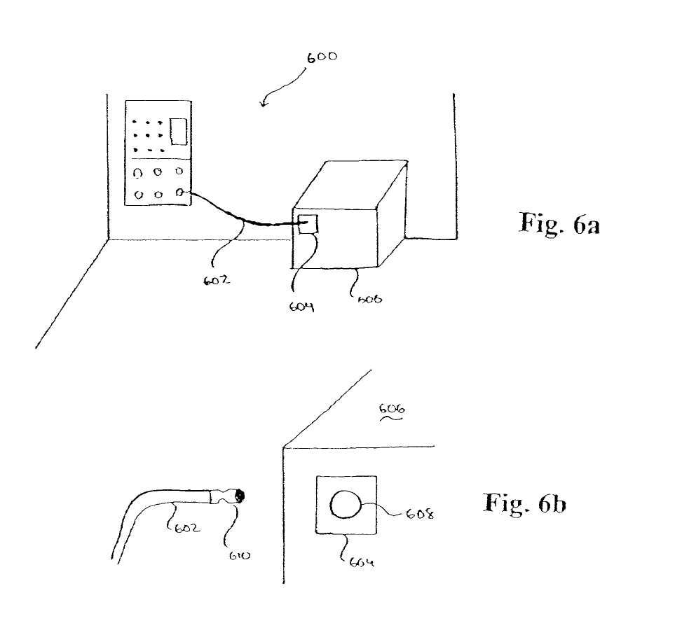

In another embodiment, a tether transfer system may be provided. Referring to FIGS. 6a and 6b, tether system 600 may use a small lanyard or plug-in that is attached to the shipping package or container. Upon delivery of a package or the positioning of a package for pick-up from a home or office, tether 602 may be received in connection 604 that is provided in container 606. Container 606 is then protected from theft until tether 602 is released by access controller 104 by a entering a code or providing a key. In an embodiment, tether 604 may be secured to container 606 in such a way that container 606 or its contents may be damaged or destroyed in order to remove container 606 without properly unlocking tether 602. Alternatively, tether 602 may be integral to the locking system on the home, and container 606 may come with either a loop (not shown) through which tether 602 may pass, or female connector 608 to match male end 610 of tether 602.

In another embodiment, a tether may be integral with the container, and may be received by a receptacle provided in the secure area. In yet another embodiment, a special container may be provided. The special container may be made of a material, such as plastic, to provide durability, and may be equipped with either a tether or a receptacle for the tether. The special container may be provided with a locking mechanism, as well.

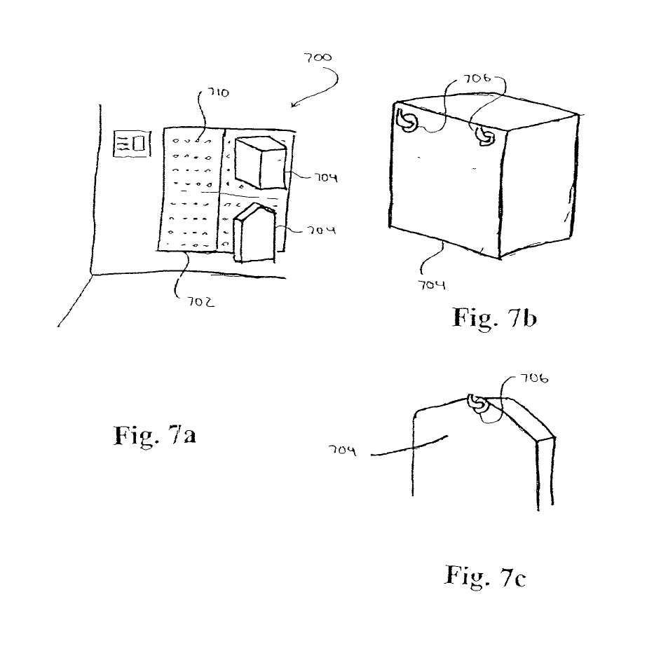

In another embodiment, a peg board transfer system may be provided. A peg board system includes one or more hooks attached to a package. In FIG. 7a, pegboard system 700 includes access controller 104 and pegboard 702, which may be divided into a plurality of zones, or regions. Packages 704, such as those shown in FIGS. 7b-c, may be delivered with pegs 706 protruding from a portion of the package. Packages 704 may include special containers that have pegs 706 formed integrally therewith, or pegs 706 may simply be attached to packages 704.

Similar to the tether design, pegs 706 are received by holes 710 in pegboard 702. Pegboard 702 may be part of a larger, home or office security system, in which any inserted pegs then may be secured in place by a locking mechanism. Packages 704 then are secure until they are released by access controller 104 through the actions of someone possessing a key (or codes that serve as a key). Pegs 706 may be secured to package 704 in such a way that package 704 or its contents may be damaged or destroyed in order to remove it without unlocking peg board 702.

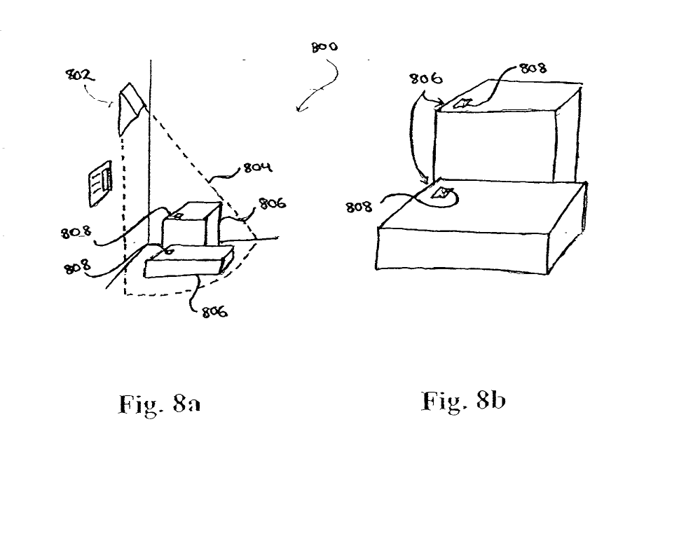

In yet another embodiment, a sensor transfer system is provided. Referring to FIGS. 8a and 8b, sensor system 800 may operate by using electric sensor 802 that emits electromagnetic signal or emission 804 covering a predetermined area. Packages 806 include sensors 808 that may be located on the outside of package 806 or within package 806. Sensor 808 may be a small chip similar in size and function to the shoplifting prevention device attached to clothing in some retail stores, such as U.S. Pat. No. 4,123,749 and U.S. Pat. No. 5,874,896. In yet another embodiment, a sensor 808 may be integrated with a special container (not shown).

Once package 806 including sensor 808 is recognized, sensor system 800 is switched into “locked” mode and maintains electronic contact with the package 806. If this contact is interrupted, a warning is provided. This may include sounding an alarm, on activating other security measures (e.g., activating an electronic camera to capture activity in the predetermined area). As with other embodiments, to remove package 806 from the area, an authorized recipient or shipping agent, or the like, may be required to possess a key or a code to disable the alarm.

Regardless of the specific embodiment, the unattended transfer device may be part of a simple physical security mechanism, or part of a device with broader functions and possessing intelligence. Similarly, the transfer device may be a single device or one element of a ganged or combination of transfer devices. For example, such functions and intelligence may include the ability to notify the homeowner office worker of delivery or pick-up of the package. For deliveries to or pick-ups from the system, input codes that identify the package may be used, so that notification may specify the package, the shipping agent, the time of delivery or pick-up, and the like.

Further, the user may register the unattended transfer device with a service provider. This may include transmitting the individual's name, social security information, home and work address, telephone and other digital/analog communication numbers or electronic mail addresses, as well as information regarding the individual's preferences as a user of the system, including preferred means of notification, preferred shipping provider, preferred transfer device pick-up times, a “buddy-list” of additional people authorized to use the device, and the like, and combinations thereof. The user also may register payment information in the central database. A preferred method of payment is a credit card; however, it is possible that payment may be accepted via a debit card, check, electronic-check (“e-check”), or electronic-wallet (“e-wallet”)—the latter two examples referencing forms of electronic payment made over the Internet.

In an embodiment of the present invention, a third party may serve as an intermediary between the user, which may be a user, including a homeowner or office worker; and the shipping agent. The third party may be referred to generally as a network agent.

In yet another embodiment of the present invention, a method for outbound shipment of packages directly from home or office is described.

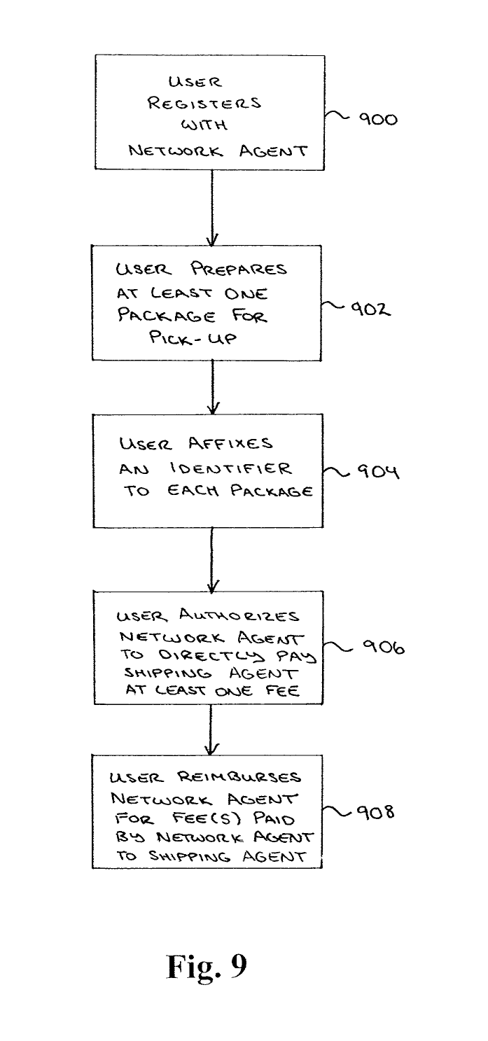

For example, the method may be used for the after hours pick-up of lab samples from medical offices and after-hours pick-up of paper receipt or bank receipts from small businesses or banks. Referring to FIG. 9, in step 900, a user may register with a network agent. Registering with the network agent may include becoming a registered user of a transfer device, and also may include receiving the transfer device from the network agent. In step 902, the user may prepare at least one package for pick-up by a shipping agent (e.g., United Parcel Service, Federal Express, or DHL). Preparing the package for pick-up by the shipping agent may include selecting which shipping agent the user wishes to have pick-up the package, and also may include selecting from various service options offered by the selected shipping agent. Such service options may include selecting between ground transport and air transport, overnight service and second day service, and the like. These selections may be supported by using pre-printed materials provided by the shipping agent, or they might be supported by web-based tools and a printer available at the user's home or office.

In step 904, a user may affix an identifier to each package. The identifier may provide identification of the network agent or the shipping agent, and also may provide identification of the user or the person to receive the package, or combinations thereof. Further, the identifier may identify the package as originating from the user, and as being supported by the network agent. The identifier may be a bar code label printed or other label from the user's home or office printer, or, alternatively, it may be a pre-printed adhesive label (e.g., an airbill). The pre-printed adhesive label may operate similarly to a postage stamp, but providing the above-described identification information. The identifier may be read using a hand-held device or bar code scanner. Further, the identifier may be specific to the package to which it is affixed, or, alternatively, may be a generic identifier of the user and the network agent. Further, the user may signal the shipping agent to pick-up the prepared package, or alternatively, the network agent may signal the shipping agent to pick-up the package. In one embodiment, the user may insert the prepared package into the transfer device.

Moreover, the user, or alternatively the network agent, may signal the shipping agent to pick up the package inserted in the transfer device by pressing at least one button, or a combination of buttons, or a series of keys, or the like, on the transfer device. Alternatively, the user or the network agent may signal the shipping agent by going on-line to a web-site supported by the shipping agent and placing an order for a pick-up. The user or network agent also may signal the shipping agent by placing a telephone call, sending an e-mail, facsimile transmission, or the like. The user or network agent also may signal for a pick up using a magnetic signature wand, an IF transmitter, wireless RF transmitter, or the like. Further, the user or the network agent may signal for a pick-up to occur while the user is at home, or alternatively, while the user is away from home or office.

In step 906, the user may authorize the network agent to directly pay the shipping agent for any fees incurred by the user. The incurred fees may be for a single pick-up by the shipping agent, or may be for multiple pick-ups (e.g., multiple pick-ups made on a single occasion or multiple pick-ups made over time). Similarly, the fees also may be for the pick-up of a single package by the shipping agent, or may be for the pick-up of multiple packages. Further, in step 908, the user may reimburse the network agent for any fees paid by the network agent to the shipping agent on the user's behalf. The user also may defer such reimbursement payment until after the package has been picked up by the shipping agent.

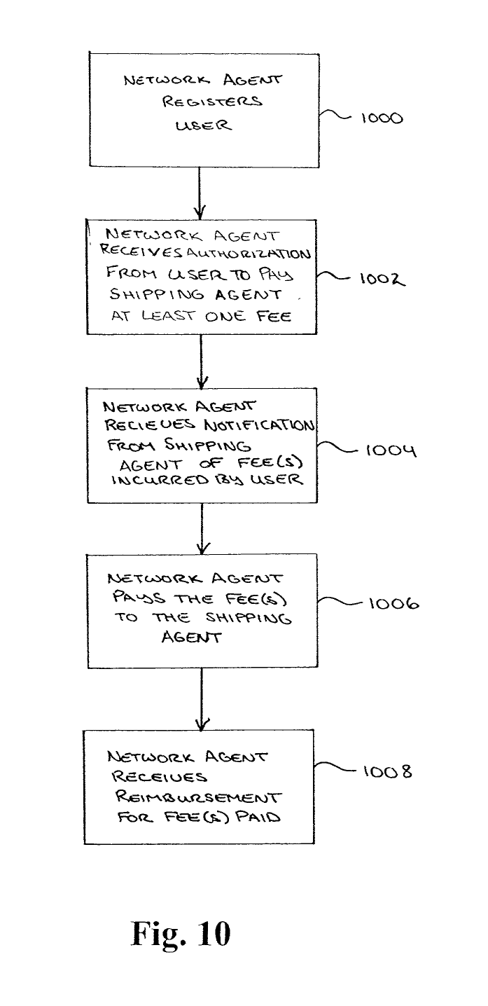

In yet another embodiment of the present invention, a method for outbound shipment of packages directly from home or office is described. Referring to FIG. 10, in step 1000, a network agent may register a user. Registration of the user may include providing the user with a transfer device. The user may prepare at least one package for pick-up by a shipping agent, and may affix an identifier to the package. The identifier may provide identification of the network agent or the shipping agent, and also may provide identification of the user or the person to receive the package, or combinations thereof. Further, the identifier may identify the package as originating from the user, and as being supported by the network agent.

The user may insert the package in the transfer device and may signal the shipping agent to pick-up the package. Alternatively, the network agent may signal the shipping agent to pick-up the package. Moreover, the user, or alternatively the network agent, may signal the shipping agent to pick up the package inserted in the transfer device by pressing at least one button, or a combination of buttons, or a series of keys, or the like, on the transfer device. Alternatively, the user, or the network agent, may signal the shipping agent by going on-line to a web-site supported by the shipping agent and placing an order for a pick-up. The user or network agent also may signal the shipping agent by placing a telephone call, sending an e-mail, facsimile transmission, or the like. The user or network agent also may signal for a pick up using a magnetic signature wand, an IF transmitter, wireless RF transmitter, or the like. Further, the user or the network agent may signal for a pick-up to occur while the user is at home, or alternatively, while the user is away from home or office.

The shipping agent may pick-up the package from the transfer device, and the user may incur at least one fee for the pick-up of the package. The incurred fees may be for a single pick-up by the shipping agent, or may be for multiple pick-ups. Similarly, the fees also may be for the pick-up of a single package by the shipping agent, or may be for the pick-up of multiple packages.

In step 1002, the network agent may receive authorization from the user to pay the shipping agent for the fee incurred by the user. In step 1004, the network agent may receive notification from the shipping agent of the fee incurred by the user. The fee may be a single fee incurred by the user, or may be a combination or an accumulation of fees incurred by the user. The shipping agent may provide the network agent with an invoice detailing the individual fees incurred by the user. In step 1006, the network agent may directly pay the shipping agent for the fee incurred by the user. Such payment may be made by check, electronic funds transfer, debit card, e-check, or e-wallet, and the like. In step 1008, the user may reimburse the network agent for all fees paid by the network agent on behalf of the user. The network agent may use the invoice provided by the shipping agent to determine the amount owed to the network agent by the user. The network agent may charge an account of the user for the fees paid by the network agent, which may allow the user to defer payment for the fee incurred for the pick-up of the package.

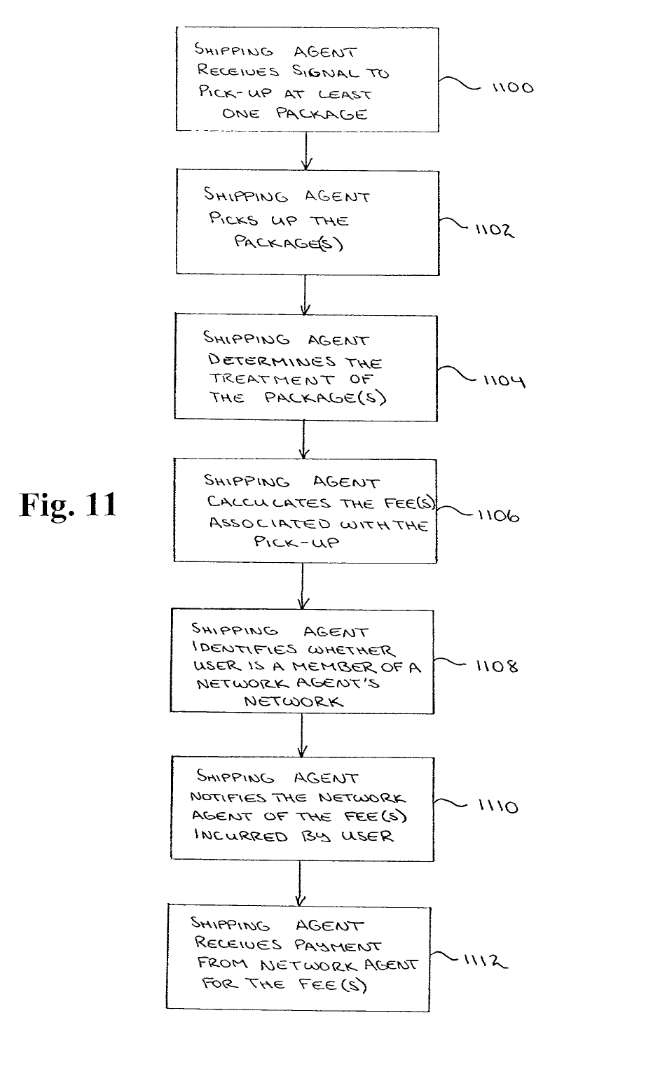

In still yet another embodiment of the present invention, a method for outbound shipment of packages directly from home or office is described. Referring to FIG. 11, a user may register with a network agent. Registering with the network agent may include becoming a registered user of a transfer device, and also may include receiving the transfer device from the network agent. The user may prepare at least one package for pick-up, which may include selecting from various service options offered by the selected shipping agent. Such service options may include selecting between ground transport and air transport, overnight service and second day service, and the like. Further, the user also may place the package in the transfer device. In step 1100, the shipping agent may receive a signal requesting the pick-up of the package. The signal may be received from the user, or alternatively, may be received from the network agent.

Moreover, the user, or alternatively the network agent, may signal the shipping agent to pick-up the package inserted in the transfer device by pressing at least one button, or a combination of buttons, or a series of keys, or the like, on the transfer device. Alternatively, the user or the network agent may signal the shipping agent by going online to a web-site supported by the shipping agent and placing an order for a pick-up. The user or network agent also may signal for a pick up using a magnetic signature wand, an IF transmitter, wireless RF transmitter, or the like. Further, the user or the network agent may signal for a pick-up to occur while the user is at home, or alternatively, while the user is away from home or office.

In step 1102, the shipping agent may pick-up the package, which may be located in the transfer device. In step 1104, the shipping agent may determine a treatment of the package. Determining the treatment of the package may include determining the shipping route for the package, determining whether the package has any special markings, or the like. Further, these determinations may be made at the moment of pick-up, or may be made at a later time. Moreover, these determinations may be made using a hand-held device to scan a bar code on the package. In step 1106, the shipping agent may determine at least one fee associated with the pick-up the package. This determination may be made based on the service options selected by the user. In addition, this determination also may be based on the weight and girth of the package. In step 1108, the shipping agent may identify whether the user is a member of the network operated by the network agent, which may include determining whether the package originated within the network operated by the network agent. This identification may be achieved automatically using a hand-held electromagnetic or bar code scanner, automated sorting system, or the like. Alternatively, this identification may be done manually. Further, step 1108 may be combined with or accomplished simultaneously with step 1104, described above.

In step 1110, the shipping agent may notify the network agent of the fee incurred by the user. The fee may be a single fee incurred by the user, or may be an accumulation of fees incurred by the user. Further, the shipping agent may provide the network agent with an invoice detailing the individual fees incurred by the user. In step 1112, the shipping agent may receive payment directly from the network agent for the fee incurred by the user. Such payment may be made by check, electronic funds transfer, debit card, e-check, e-wallet, and the like.

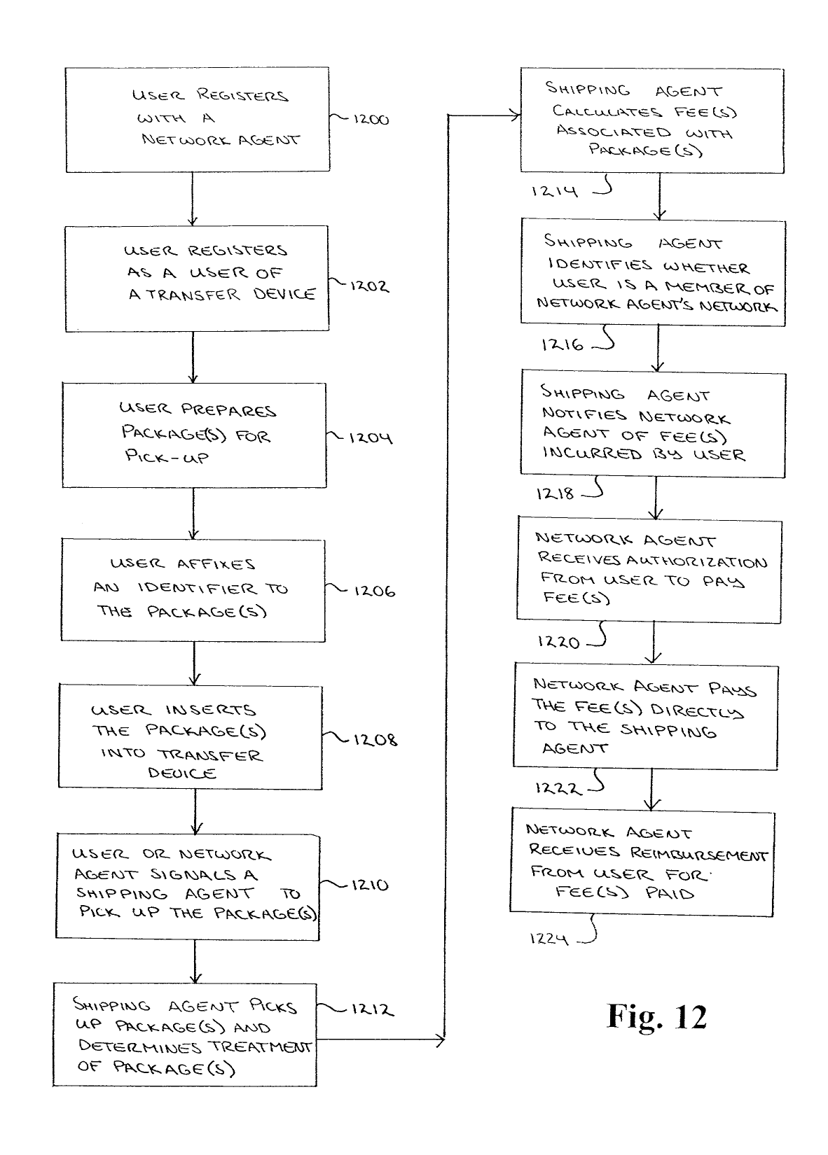

In still yet another embodiment of the present invention, a method for outbound shipment of packages directly from home or office is described. Referring to FIG. 12, in step 1200, a user may register with a network agent. In step 1202, the user may register as a user of a transfer device, which also may include receiving the transfer device from the network agent. In step 1204, the user may prepare at least one package for pick-up by a shipping agent. Preparing the package for pick-up by the shipping agent may include selecting which shipping agent the user wishes to have pick-up the package, and also may include selecting from various service options offered by the selected shipping agent. Such service options may include selecting between ground transport and air transport, overnight service and second day service, and the like.

In step 1206, a user may affix an identifier to each package. The identifier may provide identification of the network agent or the shipping agent, and also may provide identification of the user or the person to receive the package, or combinations thereof. Further, the identifier may identify the package as originating from the user, and as being supported by the network agent. The identifier may be a bar code label or other label printed from the user's home or office printer, or, alternatively, it may be a pre-printed adhesive label (e.g., an airbill). Further, the identifier may be specific to the package to which it is affixed, or, alternatively, may be a generic identifier of the user and the network agent. In step 1208, the user may insert the prepared package into the transfer device. In step 1210, the user may signal the shipping agent to pick-up the package stored in the transfer device, or alternatively, the network agent may signal the shipping agent to pick-up the package.

Moreover, the user, or alternatively the network agent, may signal the shipping agent to pick up the package inserted in the transfer device by pressing at least one button, or a combination of buttons, or a series of keys, or the like, on the transfer device. Alternatively, the user or the network agent may signal the shipping agent by going on-line to a web-site supported by the shipping agent and placing an order for a pick-up. The user or network agent also may signal the shipping agent by placing a telephone call, sending an e-mail, facsimile transmission, or the like. The user or network agent also may signal for a pick up using a magnetic signature wand, an IF transmitter, wireless RF transmitter, or the like. Further, the user or the network agent may signal for a pick-up to occur while the user is at home, or alternatively, while the user is away from home or office.

In step 1212, the shipping agent may pick-up the package, and also may determine a treatment of the package. Determining the treatment of packages may include the determination of shipping costs, including a base rate and additional or optional charges; identification of the designated payor for fees associated with each package; determining whether the packages bear any special instructions or markings (e.g., Fragile); sorting of packages for appropriate handling, routing, and shipment; and the like; and combinations thereof. In step 1214, the shipping agent may determine at least one fee associated with the pick-up the package. This determination may be made based on the service options selected by the user. In addition, this determination also may be based on the weight and girth of the package. In step 1216, the shipping agent may identify whether the user is a member of the network operated by the network agent, which may include determining whether the package originated within the network operated by the network agent. This identification may be achieved automatically using a hand-held electromagnetic or bar code scanner, automated sorting system, or the like. Alternatively, this identification may be done manually. Further, step 1216 may be combined with or accomplished simultaneously with step 1214, described above.

In step 1218, the shipping agent may notify the network agent of the fee incurred by the user. The fee may be a single fee incurred by the user, or may be an accumulation of fees incurred by the user. Further, the shipping agent may provide the network agent with an invoice detailing the individual fees incurred by the user.

In step 1220, the network agent may receive authorization from the user to pay the fee incurred by the user to the shipping agent. In step 1222, the network agent may directly pay the shipping agent for the fee incurred by the user. Such payment may be made by check, electronic funds transfer, and the like. In step 1224, the network agent may receive reimbursement for all fees paid by the network agent on behalf of the user. The network agent may use the invoice provided by the shipping agent to determine the amount owed to the network agent by the user. The network agent may charge an account of the user for the fees paid by the network agent, which may allow the user to defer payment for the fee incurred for the pick-up of the package.

While the invention has been described in connection with preferred embodiments and examples, it will be understood by those skilled in the art that other variations and modifications of the preferred embodiments described above may be made without departing from the scope of the invention. Other embodiments will be apparent to those skilled in the art from a consideration of the specification or practice of the invention disclosed herein. It is intended that the specification is considered as exemplary only, with the true scope and spirit of the invention being indicated by the following claims.

What is claimed is:

1. A method for outbound shipment of packages directly from home or office, comprising the steps of:
registering with a network agent;
preparing at least one package for pick-up;
affixing an identifier to each package;
authorizing the network agent to directly pay a shipping agent at least one fee; and
reimbursing the network agent for the at least one fee paid directly to the shipping agent by the network agent.

2. The method of claim 1, wherein the identifier provides identification for the network agent.

3. The method of claim 1, wherein the identifier provides identification of the shipping agent.

4. The method of claim 1, wherein the identifier provides identification for a receiver of each package.

5. The method of claim 1, further comprising the steps of:
registering a user of a transfer device;
receiving the transfer device from the network agent; and
inserting the at least one package in the transfer device for pick-up by the shipping agent.

6. The method of claim 5, further comprising the steps of:
signaling the shipping agent to pick-up the at least one package.

7. The method of claim 5, wherein the step of preparing a package for pick-up further comprises the steps of:
selecting the shipping agent to pick-up the at least one package; and
selecting from a plurality of service options offered by the shipping agent.

8. The method of claim 5, wherein the identifier also provides identification of the user and identifies the at least one package as originating from the user and as being supported by the network agent.

9. The method of claim 6, wherein the shipping agent is signaled by a signaler selected from the group consisting of the user and the network agent.

10. The method of claim 9, wherein the signal is transmitted by a means selected from the group consisting of telephone, internet, web-site, and facsimile transmission.

11. The method of claim 5, wherein the at least one fee is incurred by the user.

12. A method for outbound shipment of packages directly from home or office, comprising the steps of:
registering a user;
receiving authorization from the user to pay a shipping agent at least one fee incurred by the user;
receiving a notification from the shipping agent of the at least one fee incurred by the user;
paying the at least one fee directly to the shipping agent; and
receiving reimbursement from the user for the payment of the at least one fee to the shipping agent.

13. The method of claim 12, further comprising the steps of:
providing the user with a transfer device.

14. The method of claim 13, wherein the user inserts the at least one package in the transfer device for pick-up by the shipping agent.

15. The method of claim 14, wherein the user affixes an identifier to each package, wherein the identifier provides identification of at least one selected from the group consisting of the shipping agent, the user, and a network agent.

16. The method of claim 13, further comprising the steps of:
signaling the shipping agent to pick-up the at least one package.

17. The method of claim 16, wherein the shipping agent is signaled by a signaler selected from the group consisting of the user and the network agent.

18. The method of claim 17, wherein the signal is transmitted by a means selected from the group consisting of telephone, internet, web-site, and facsimile transmission.

19. A method for outbound shipment of packages directly from home or office, comprising the steps of:
receiving a signal for a pick-up of at least one package;
picking up the at least one package;
determining a treatment of the at least one package;
calculating at least one fee associated with the pick-up of the at least one package;
identifying whether the user is a member of a network operated by a network agent;
notifying the network agent of the at least one fee incurred by the user; and
receiving payment from the network agent for the at least one fee incurred by the user.

20. The method of claim 19, further comprising the steps of:
providing a plurality of service options from which the user may select; and
receiving a selection from a user from the plurality of service options provided.

21. The method of claim 20, wherein the user is a registered user of a transfer device and the transfer device is provided by the network agent.

22. The method of claim 20, wherein the step of picking up the at least one package further comprises the step of picking up the at least one package from a transfer device.

23. The method of claim 21, wherein the step of determining a treatment of the at least one package further comprises the step of determining a shipment route for the at least one package.

24. The method of claim 22, wherein determining the treatment of the at least one package is achieved using a hand-held device.

25. The method of claim 21, wherein identifying whether the user is a member of the network operated by the network agent is achieved using at least one selected from group consisting of a hand-held scanner and an automated sorting system.

26. The method of claim 24, wherein the step of identifying whether the user is a member of a network operated by a network agent further comprises the step of determining the fee associated with each package.

27. The method of claim 20, wherein the shipping agent is signaled by a signaler selected from the group consisting of the user and the network agent.

28. The method of claim 27, wherein the signal is transmitted by a means selected from the group consisting of telephone, internet, web-site, and facsimile transmission.

29. A method for outbound shipment of packages directly from home or office, comprising the steps of:
registering with a network agent;
registering as a user of a transfer device;
preparing at least one package for pick-up;
affixing an identifier to each package, wherein the identifier provides identification of the network agent;
inserting the at least one package in the transfer device
signaling a shipping agent to pick-up the at least one package from the transfer device;
picking up the at least one package;
determining a treatment of the at least one package;
calculating at least one fee associated with the pick-up of the at least one package, wherein the at least one fee is incurred by the user;
identifying whether the user is a member of a network operated by the network agent;
notifying the network agent of the at least one fee incurred by the user;
receiving authorization from the user to pay the at least one fee directly to the shipping agents;
paying the at least one fee directly to the shipping agent; and
receiving reimbursement from the user for the payment of the at least one fee to the shipping agent.
